(19) United States
(12) Patent Application Publication
(10) Pub. No.: US 2015/0282469 A1
(43) Pub. Date: Oct. 8, 2015

(54) FISHING APPARATUS

(71) Applicant: Jerry Fizer, Colorado Springs, CO (US)

(72) Inventor: Jerry Fizer, Colorado Springs, CO (US)

(21) Appl. No.: 14/677,616

(22) Filed: Apr. 2, 2015

Related U.S. Application Data
(60) Provisional application No. 61/974,150, filed on Apr. 2, 2014.

(51) Int. Cl. A01K 97/12; G01L 5/04; H04L 29/08; A01K 91/03; G08B 21/18

(52) U.S. Cl. CPC A01K 97/125; A01K 91/03; G08B 21/182; H04L 67/10; G01L 5/047

(57) ABSTRACT

A fishing apparatus includes a housing, a spring fitted into a space of the housing, a cylinder fitted into the space, where the spring is configured to act against the housing and the cylinder, and a hooked-wire fitted into a length of the cylinder, where the hooked-wire comprising a hook end, where the cylinder is configured to compress the spring at an application of a pressure and to expose the hook end of the hooked-wire, and where a fishing line is configured to be hooked onto the hook end. An interior side of the housing includes a fitting configured to fit the housing on a bottle. The fishing apparatus further includes one or more components at an end of the housing, wherein the components are inside the bottle when the housing is fitted on the bottle.

### CROSS REFERENCE TO RELATED APPLICATION

The present application claims the benefits of and priority, under 35 U.S.C. §119(e), to U.S. Provisional Application Ser. No. 61/974,150, filed Apr. 2, 2014; the above-identified application being fully incorporated herein by reference.

### BACKGROUND OF THE INVENTION

### Field of the Invention

The present invention generally relates to a fishing apparatus and more specifically to a bobber for fishing and methods of using and making thereof.

### SUMMARY OF THE INVENTION

The present disclosure can provide a number of advantages depending on the particular aspect, embodiment, and/or configuration. These and other advantages will be apparent from the disclosure. Additional features and advantages may be learned by the practice of the invention.

To achieve these and other advantages, as embodied and broadly described, a fishing apparatus includes a housing, a spring fitted into a space of the housing, and a cylinder fitted into the space. The spring is configured to act against the housing and the cylinder. The fishing apparatus further includes a hooked-wire fitted into a length of the cylinder, the hooked-wire comprising a hook end. The cylinder is configured to compress the spring at an application of a pressure and to expose the hook end of the hooked-wire, and a fishing line is configured to be hooked onto the hook end.

According to another embodiment, a fishing apparatus includes a housing, a rod attached to an end of the housing, and a hook at an end of the rod. A fishing line is configured to be hooked onto the hook.

According to yet another embodiment, a linked fishing apparatus includes one or more fishing apparatuses, one or more weights, and one or more baits. The fishing apparatuses, weights, and baits are linked. Each of the fishing apparatuses includes a housing, a spring fitted into a space of the housing, and a cylinder fitted into the space. The spring is configured to act against the housing and the cylinder. The fishing apparatus further includes a hooked-wire fitted into a length of the cylinder, the hooked-wire comprising a hook end. The cylinder is configured to compress the spring at an application of a pressure and to expose the hook end of the hooked-wire, and a fishing line is configured to be hooked onto the hook end.

It is to be understood that both the foregoing general description and the following detailed description are exemplary and explanatory and are intended to provide further explanation of the invention as claimed.

The present disclosure can provide a number of advantages depending on the particular aspect, embodiment, and/or configuration. These and other advantages will be apparent from the disclosure.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “module,” as used herein, refers to any known or later developed hardware, software, firmware, artificial intelligence, fuzzy logic, or combination of hardware and software that is capable of performing the functionality associated with that element.

The terms “determine,” “calculate,” and “compute,” and variations thereof, as used herein, are used interchangeably and include any type of methodology, process, mathematical operation or technique.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible, utilizing, alone or in combination, one or more of the features set forth above or described in detail below.

### BRIEF DESCRIPTION OF THE FIGURES

The accompanying figures, which are included to provide a further understanding of the invention are incorporated in and constitute a part of this specification, illustrate embodiments of the invention and together with the description serve to explain the principles of the invention.

FIG. 1 illustrates exemplary front views of a bobber cap according to an embodiment;

FIG. 2 illustrates an exemplary view of a housing of a bobber cap according to an embodiment;

FIG. 3 illustrates an exemplary cross-section view of a housing of a bobber cap according to an embodiment;

FIG. 4 illustrates an exemplary view of a bobber cap according to an embodiment;

FIG. 5 illustrates an exemplary view of a bobber cap according to an embodiment;

FIG. 6 illustrates an exemplary view of an installed bobber cap according to an embodiment;

FIG. 7 illustrates an exemplary view of linked bobber caps according to an embodiment;

FIG. 8 illustrates an exemplary block diagram of a communication system for a bobber cap network according to an embodiment of the invention; and

FIG. 9 illustrates an exemplary block diagram of a bobber cap device according to an embodiment of the invention.

### DETAILED DESCRIPTION OF THE PREFERRED EMBODIMENTS

In order to more fully appreciate the present disclosure and to provide additional related features, each of the following references are incorporated herein by reference in their entirety.

U.S. Pat. No. 5,372,532 to Robertson, Jr. is directed to a swivel head cap assembly that can be threadedly attached to an empty plastic pop bottle to create a float or buoy. The assembly includes a cap that is attachable to the bottle, and the cap includes an annular collar spaced from the cap by a pair of integrally moulded legs. A separate eyebolt member has an annular eyebolt portion and a shaft portion extending radially therefrom, and the shaft portion being receivable in the collar of the cap. A separate securing member is provided to prevent unwanted disconnection of the eyebolt member from the cap. The eyebolt member can rotate or swivel relative to the cap and a rope or chain can be connected at one end to the eyebolt portion and at the other end to a net or other underwater structure.

U.S. Pat. No. 5,829,181 to Fielder et al. is directed to a jugfishing apparatus and signaling device for indicating to a jugfisherman that a fish has struck the bait. The signaling device can include an illumination device such as a light bulb, or an audible signal. When a fish strikes the bait, the signaling device is activated and remains so until deactivated by the fisherman. The force necessary to trigger the signaling device can be adjusted along a continuous range for a variety of fishing conditions, to implement different fishing tactics, and to allow the use of any of a number of standard-size buoyant containers.

U.S. Pat. No. 5,265,369 to Botkins is directed to a device for use in a jug fishing apparatus that has a closure lid portion adapted to be securable onto a male threaded lip of a conventional wide-mouth plastic jar. A spool portion forwardly emergent from the closure lid portion and having axial and radial bores to accommodate a length of spirally wound fishing line which passes through the bores. A circular flange forwardly emergent from the spool portion and penetrated by the line has a rearwardly facing convex surface and forwardly facing concave surface.

U.S. Pat. No. 6,763,629 to Bennett is directed to a free floating fishing apparatus that includes a float and a spool that is positioned on the float for holding a supply of line to be dispensed. A hook setting trigger mechanism is mounted on the float and has a line guide that enables a fishing line to be spooled from the spool through the line guide and then underwater for fishing. Rigging such as a hook, sinker, or the like can be attached to the free end portion of a line. The trigger assembly includes an arm that is pivotally movable between extended and retracted positions. The arm is spring loaded to bias the arm toward the retracted position. A sear plate enables the arm to be retained in an intermediate position that is in between the extended and retracted positions, but closer to the extended position. The sear plate is spring loaded to move the sear out of engagement with the arm when the arm is moved beyond the intermediate position toward the extended position such as when a fish bites the hook and pulls on the line. The arm includes a line support that holds the line so that when the arm travels under spring tension toward the retracted position, the line below the float is pulled quickly for setting the hook.

U.S. Pat. No. 7,131,231 to Lee is directed to a multi-function electronic fishing float having an identification number and automatically generates radio frequency (RF) signals, if a fish takes bait or is hooked. The generated RF signal is sent to a receiver, and an angler can clearly identify a sign of a fish's bite or hooking through sound, vibration, or light generated by the receiver, without checking the float with eyes. A transmitter sending RF signals corresponding to the fish's bite or hooking is installed in the electronic fishing float that partially comes up above the water surface by buoyancy, and the transmitted RF signals are received by the receiver outputting sound, vibration, and light as information on the fish's bite or hooking.

U.S. Pat. Pub. No. 2011/0138675 to Cutts is directed to a Radio Controlled Fish Finding Lure Float that combines recasting, trolling, and fish finding capability into one unit, while keeping the water and the environment as undisturbed as possible. More advanced releases of this technology allow for the detection of a force hitting the end of the lead line. Similarly, means for indicating the submergence of the float can be added to even more advanced models. The addition of global positioning technology to the float allows for the recording of locations and monitoring of aquatic life in specific areas. The addition of the remotely controlled lead line spool winch aids the control of depth of the lead line. By combining the above features onto a larger, more stable platform, and with the aid of solar collectors, cameras, and a tether line spool, unmanned automated activities may be controlled from afar by computer systems for the aid in rudimentary offshore operations.

Reference will now be made in additional detail to an embodiment of the present invention, examples of which are illustrated in the accompanying figures.

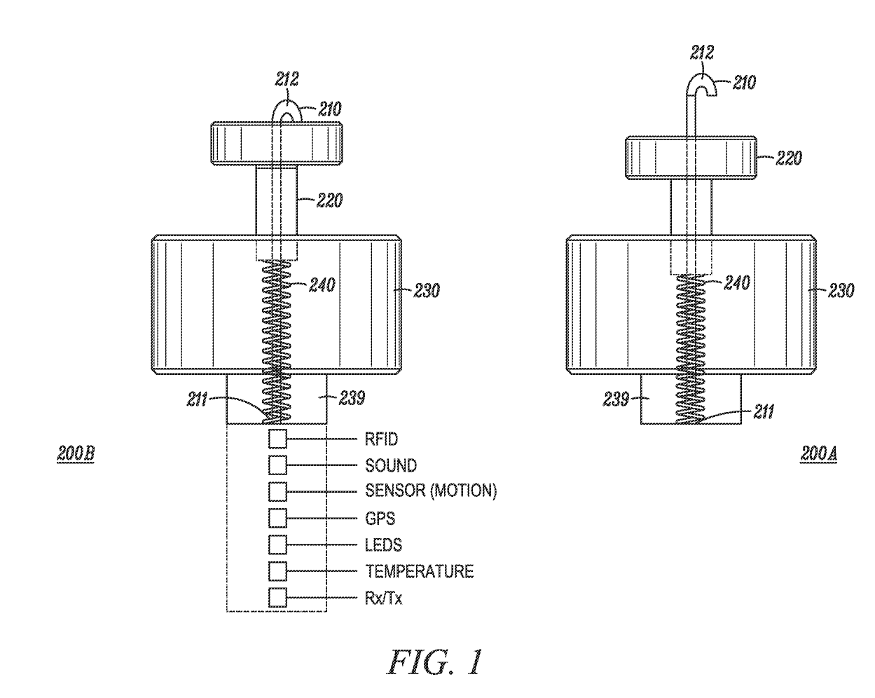

FIG. 1 illustrates exemplary front views of a bobber cap according to an embodiment.

Referring to FIG. 1, according to an embodiment, the bobber cap includes a housing 230 (including a stem portion 239), which houses a hooked-wire 210 (with a straight end 211 and a hooked end 212), cylinder 220, and a tension spring 240. The bobber cap with the tension spring 240 in an uncompressed in 200B, and the bobber cap with the tension spring 240 compressed is shown in 200A. The tension spring 240 is housed inside the housing 230 and acts against the cylinder 220.

In an embodiment, the bobber cap may be assembled as follows. Preferably, the housing 230 with the stem portion 239 are molded as one piece. The tension spring 240 is placed inside the housing 230 with an end of the tension spring 240 fitted in the interior space of the stem portion 239 and pushes against the end wall of the stem portion 239. The cylinder 220 (e.g., a narrow end of the cylinder 220) is also inserted into the housing 230 such that another end of the tension spring 240 may be pushed up against the inserted end of the cylinder 220. The inserted end of the cylinder 220 may be secured such that at least a portion of the cylinder 220 (e.g., the inserted end) is prevented from being released from the housing 230 (e.g., by some retention mechanism such as an integrated plate or other mechanisms).

The hooked-wire 210 also inserted into the housing 230 such that the straight end 211 is secured to the housing 230 (e.g., the bottom of the stem portion 239). The hooked-wire 210 is also threaded through the cylinder 220 (when the cylinder 220 is inserted into the housing 230) such that the hooked end 210 extends from the top end of the cylinder 220 (e.g., the end not inserted into the housing 230), where the hooked-wire 210 is at least partially held in place (e.g., held in a vertical orientation) by the cylinder 220 (e.g., the interior of the cylinder 220 includes a channel for threading and holding in place the hooked-wire 210). In preferred configuration, the hooked-wire 210 may also be threaded through the interior of the tension spring 240 (e.g., the open space in the interior of the tension spring 240). The top portion of the cylinder 220 may include two openings, one for the channel threading the hooked-wire 210 and one for resting the hooked end 212 of the hooked-wire 210. In one configuration, the hooked end 212 may act as a retention mechanism of the cylinder 220. For example, when the hooked-wire 210 is of a fixed length (that is shorter than the combined length of the housing 230 and the cylinder 220), the attachment of the hooked-wire 210 to the housing 230 prevents the release of the cylinder 220 from the housing 230 when the hooked end 212 prevents the movement of the top of the cylinder 220 any farther than the length of the hooked-wire 210.

It is noted that the hooked-wire 210 is relatively fixed (e.g., immobile over the length of the hooked-wire 210) while the cylinder 220 may move in a vertical direction (e.g., being more or less inserted into the housing 230) by the compression of the tension spring 240 that is holding the cylinder 220 against the stem portion 239 of the housing 230. This mechanism will be explained below.

Preferably, the bobber cap may be made of plastic, metal, or other types of suitable materials. The hooked-wire may be made of metal or other suitable materials. In an embodiment, the bobber cap may be made of clear materials such that the interior of the bobber cap may be visible.

At the natural state (uncompressed state) 200B, the tension spring 240 is uncompressed and pushed the cylinder 220 towards the hooked end of the hooked-wire 210. The tension spring 240 is compressed when the cylinder 220 is pushed down (as shown in 200A). The portion of hooked-wire 210 that is just beneath the hooked end 212 would be bared from the cylinder 220. As such, the bared portion leaves room to allow a fishing line to be inserted into the hooked-wire 210. After the fishing line is inserted into the hooked wire 210, compression of the tension spring 240 may be released (e.g., releasing the force pushing down on the cylinder 220). The tension spring 240 may then uncompress and return the cylinder 220 to the natural state (as shown in 200B), thus clamping the fishing line in place between the cylinder 220 and the hooked-wire 210 (e.g., at the hooked end 212).

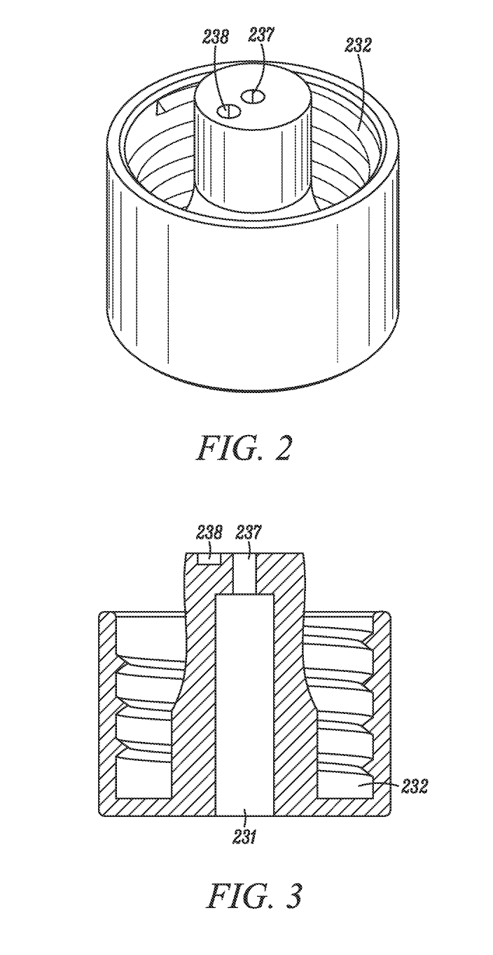

FIG. 2 illustrates an exemplary view of a housing of a bobber cap according to an embodiment. FIG. 3 illustrates an exemplary cross-section view of a housing of a bobber cap according to an embodiment.

Referring to FIGS. 2-3, exemplary views of the housing 230 are shown. The inside of the housing 230 may include a space 231 for accommodating a spring as discussed above. The channel 237 may be used for threading the hooked-wire 210, and the opening 238 may be used for resting the hooked-end 212, as discussed above. The inside of the housing 230 includes treads 232 as part of a screw-on fitting.

In an embodiment, the bobber cap is configured to replace a bottle cap of a bottle with the bobber cap that houses the tension spring 240, hooked-wire 210, and a cylinder 220 that interfaces between the tension spring 240 and the hooked-wire 210 as discussed above. As such, the bobber cap may be used to convert a common bottle into a fishing float. In one embodiment, the bobber cap may be fitted with other fittings as now known or may be later derived in the art. For example, a screw-on fitting is shown in FIGS. 2-3; the bobber cap may use other fittings such as a compression fitting or a twist-lock fitting.

As discussed above, the bobber cap may then be screwed onto a bottle, e.g., soda bottles, liquor bottles, and other bottles. In some embodiments, the bobber cap may be of various size for accommodating various sized bottles, e.g., a larger size cap may be dimensioned to fit most 20 oz to 2 liter bottles.

Further referring to FIG. 1, the bobber cap 200B may include further electronics and other components. For example, one or more electronics, mechanical, or other components that facilitate reading or outputting information may be attached to the stem portion 239 of the housing 230. The components may include various reading components such as sensors and geolocation devices (e.g., Global Positioning System (GPS) receiver). The components may also include various output components such as lights (e.g., light emitting diodes (LED)) and sound producing devices (e.g., speakers). The components may also include networking components such as various networking transmitters and receivers (e.g., wifi) and tags (e.g., radio frequency identifier (RFID)). In an embodiment, the component may be a glowstick that lights up.

In an embodiment, the components are attached to the stem portion 239 of the housing 230. As such, when the bobber cap is attached to a bottle, the components are fitted inside the bottle. In one embodiment, the components may not be permanently attached to the housing of the bobber cap but may be removed and replaced with alternate or additional components, e.g., modular. As such, the bobber cap is replaceable and upgradable with additional electronics, and third parties are able to make add-ons to the bobber cap. Further, any electronics are shielded from the water by being sealed into a water-proof bottle.

In an embodiment, the components may be attached to the stem portion 239 through a number of fittings as now known or may be later derived that would facilitate attachment and removal of the components to the bobber cap. For example, the exterior of the stem portion 239 may include helical treads (e.g., for a screw-on fitting) and the interior of the top of the component may include corresponding helical treads so that the component may be screwed on to the stem portion 239. In other examples, other fittings may be used (e.g., twist-lock fitting, compression fitting). In another embodiment, a standard fitting (e.g., a screw-on fitting) may be used as the default at the stem portion 239. An adapter may include a corresponding fitting (e.g., the corresponding screw-on fitting) at one end for attachment to the stem portion 239 and another fitting at the other end of the adapter for fitting components with non-standard fittings (e.g., when the component is oversized or otherwise unfeasible to facilitate the standard fitting).

In an exemplary embodiment, a component may include color lights, e.g., LEDs, glowsticks, or the like. In an application, the color lights may be coupled to a pressure or force sensor that will light up when sufficient force is pulled on the hooked-wire. For example, this may indicate that a fish has been hooked by the bait by the detection of a sufficient pressure or force. Further, the color lights may be lit to different colors pertaining to the size of the force. For example, the color may be red if it is a nibble or green if the force is greater. This may be used to distinguish various fish, e.g., fish species, type, size, and other characteristics. In another embodiment, a component may be used to attract various types of fish. For example, fishes are attracted to colored lights, blinking lights, and other various setups. Further, a component may be heated or scented to attract various types of fishes.

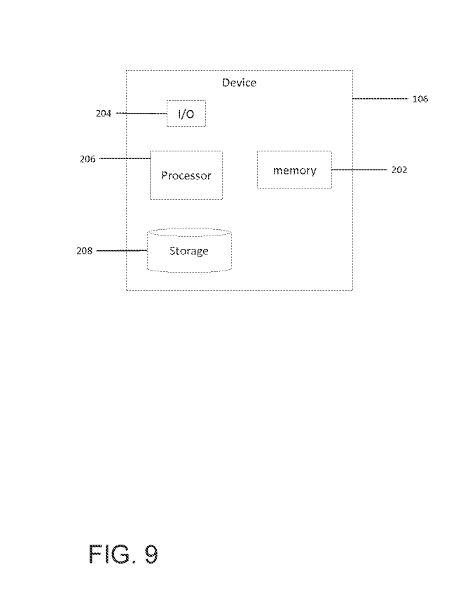

In an embodiment, the components may include network components for further functions, which will be described with respect to FIGS. 9-10. In one embodiment, if the component does not include active network components, it may contain an RFID component or other passive identification and communication components as known now or may be later derived.

In an embodiment, a component may include a power source. The bobber cap may also include a main power source that any components may draw power from.

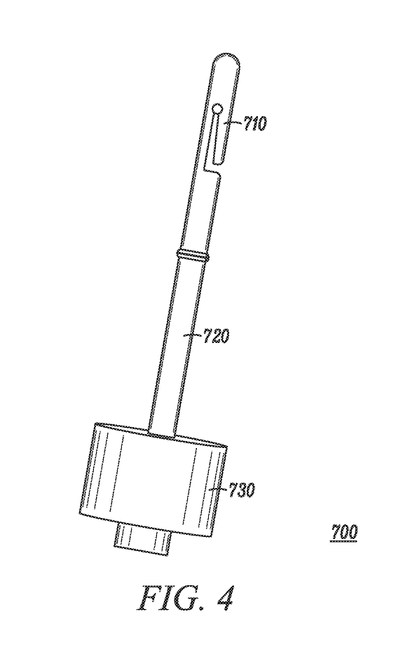

FIG. 4 illustrates an exemplary view of a bobber cap according to an embodiment.

Referring to FIG. 4, according to an embodiment, the bobber cap 700 includes a housing 730, a rod 720, and a hook 710. Similar to the bobber cap 200 as described with respect to FIGS. 1-3, the housing 730 of the bobber cap 700 includes a threads for replacing a bottle cap or when installing the bobber cap 700 onto a bottle. Electronics and mechanical components may be installed onto the housing similar to the housing of bobber cap 200.

The bobber cap 700 includes a rod 720 and a hook 710. In this embodiment, the rod 720 and the hook 710 are outside of the bottle when installed. The fishing line is configured to be hooked onto the hook 710. In an embodiment, the rod may be placed onto and protrudes from a cavity of the housing 730. Tension springs may be loaded inside the rod 720 and may clamp the fishing line onto the hook 710 similar to the bobber cap 200. In another embodiment, a spring is not needed and a user ties the fishing line onto the hook 710. As such, one feature of the bobber cap 700 is that it may be molded as a single piece without movable parts. A further feature of the bobber cap 700 is that the housing 730 may be shorter than the housing 230 of bobber cap 200 because the bobber cap 700 does not require the cylinder 220.

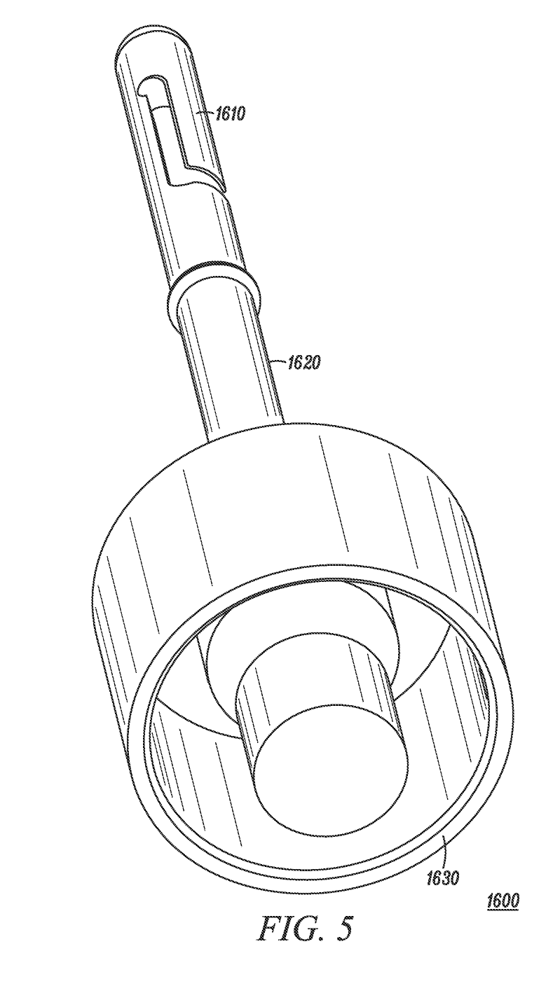

FIG. 5 illustrates an exemplary view of a bobber cap according to an embodiment.

Referring to FIG. 5, a bobber cap 1600 includes a housing 1630, a rod 1620, and a hook 1610. In an embodiment, the bobber cap 1600 is similar to bobber cap 700 but with a shorter rod 1620. The length of the rods may be variable depending on the need of the user.

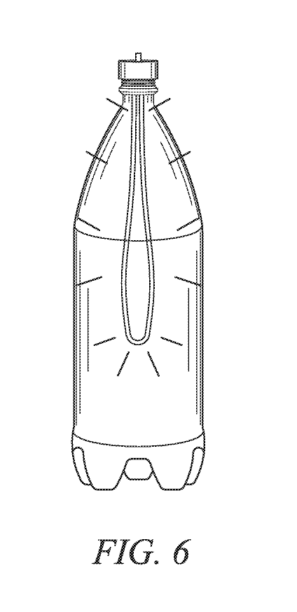

FIG. 6 illustrates an exemplary view of an installed bobber cap according to an embodiment.

Referring to FIG. 6, according to an embodiment, a bobber cap is shown installed onto a standard size bottle (e.g., a used 20 oz soda bottle). Preferably the bottle is made of transparent plastic or glass of clear or other tinted colors. The bobber cap is attached onto the bottle by being screwed on to the bottle as a replacement for the original bottle cap (not shown). The top of the bobber cap (e.g., hooked-wire 210 or rods 720 or 1620) is left at the exterior of the bottle (e.g., for being threaded to a fishing wire) as a result of the attachment of the bobber cap to the bottle. A component is attached to the bottom of the bobber cap (e.g., the stem portion 239) and is left at the interior of the bottle (shielding the component, which may be an electrical component, from elements outside of the bottle (e.g., water when the bobber cap and bottle assembly is used in a body of water for fishing)). Here, the component may be a light source (e.g., glowstick) of clear or other color. When the light source is activated, the color of the light source passes through a transparent bottle or may be filtered by a tinted bottle (and the light when viewed from the exterior of the bottle will include a color of the tint).

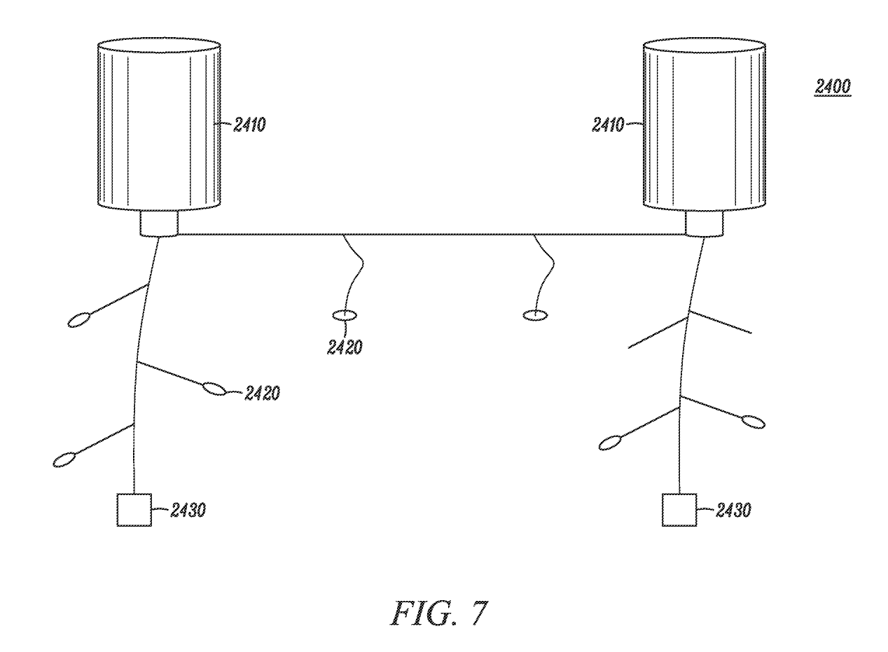

FIG. 7 illustrates an exemplary view of linked bobber caps according to an embodiment.

Referring to FIG. 7, according to an embodiment, multiple bobber caps may be linked for jug fishing. The jug fishing network 2400 includes one or more bobber caps 2410 installed to the corresponding bottles, the bobber caps are linked through fishing lines with one or more hooks 2420. One or more weights 2430 are also linked to through the fishing lines to the jug fishing network 2400; the one or more weights 2430 are usually placed at the end of the fishing line. The one or more installed bobber caps floats the jug fishing network 2400 at or near the surface of the water and the one or more weights 2430 pulls the jug fishing network 2400 towards the bottom of the water. As such, the hooks 2420 may be scattered about the network for hooking fishes in the area. The jug fishing network 2400 may further be secured, i.e., tied to a fixed object or location, i.e., at shore, or may be free floating.

In a method of using the jug fishing network 2400 according to an embodiment, bobber caps 2410 may be fitted with a number of color lights components. The color of the lights may change to a preferred color based on the fish a user wishes to catch. For example, if the user finds out a specific color would attract “bass fish”, then the color light may be tuned to that color. Once the light has attracted a fish to bite on one of the hooks 2420, a pressure or force sensor component may detect the fish bite. The color light may then be tuned to a specific color, e.g., red, to inform the user of the bite, if a fish is detected to be hooked to a hook 2420. The color light may further be tuned to another specific color, e.g., green, to inform the user of the caught fish.

In one embodiment, other components may be used, i.e., scent producing components, sound producing components, and motion producing components. In one embodiment, pressure or force detecting components may reside with the hook 2420. Notice of the bite or hook may be sent to the component in the bobber cap 2410 through mechanical means, i.e., motion and/or tension of the wire, or electrical means, i.e., wireless or wired electronic signals. The fishing line may be composed of or include materials for which an electrical signal may be sent through. The one or more bobber caps 2410 may also be linked and communicable with each other on detection or other events.

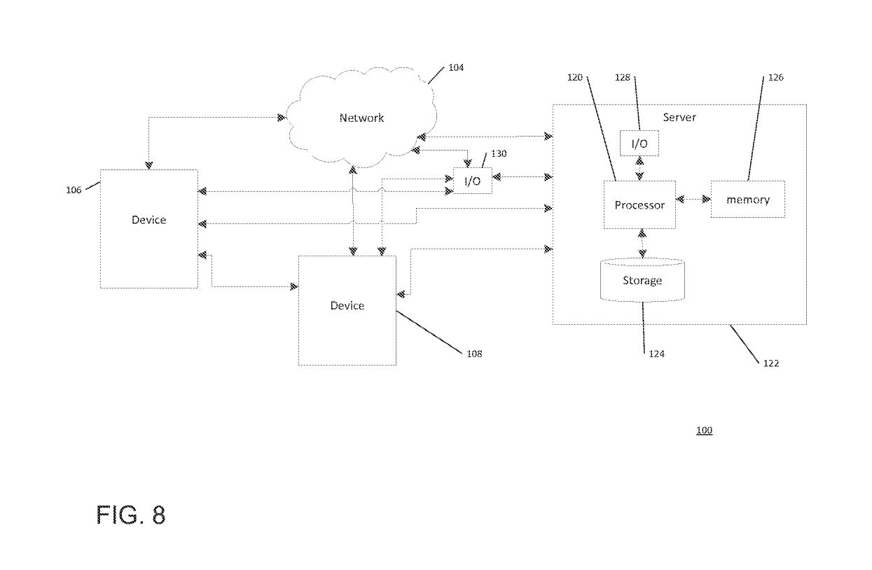

FIG. 8 illustrates an exemplary block diagram of a communication system for a bobber cap network according to an embodiment of the invention. FIG. 9 illustrates an exemplary block diagram of a bobber cap device according to an embodiment of the invention.

Referring to FIGS. 8 and 9, a bobber cap network communication system is generally depicted with reference to number 100. In this embodiment, the system 100 includes a server 122 in communication over a network 104 with one or more bobber cap devices 106 and 108 via one or more network interfaces or other communication interfaces and channels as known in the art or may be later derived. In an embodiment, one or more I/O 130 is also in communication over the network 104. In one embodiment, the server 122 includes a processor 120, a memory 126, I/O 128, and storage 124. The bobber cap devices 106 and 108 may also each include a processor 206, a memory 202, I/O 204, and storage 208 in communication with each other. In an embodiment, the bobber cap devices 106 and 108 and the server 122 may lack one or more of the process, memory, I/O, and storage depending on the application.

The server 122 and the bobber cap devices 106 and 108 may each be configured to send, receive, process, evaluate, program, and otherwise process modules according to the invention either singly or in combination. The server 126 may be configured to locate, e.g., wirelessly locate, the position of one or more of the bobber cap devices using methods known now or may be later derived, e.g., triangulation, GPS, Wi-Fi estimation or other estimation techniques. In addition, the system 100 is configured to process the modules or functional units as described herein.

In an embodiment, the bobber cap device 106 may be a bobber cap that has a component such as a wireless interface for sending information collected by its components, e.g., pressure and force sensors, to a server, cloud, mobile device, or other devices capable of receiving the information sent by the bobber cap device 106. The bobber cap device 108 may be a mobile device of the user that is configured to communicate with the bobber cap device 106.

In an embodiment, the bobber cap device 108 may relay instructions from the user to the bobber cap device 106 for controlling the bobber cap device. For example, the bobber cap device 108 may run an application that is configured to relay commands to the bobber cap device 106 for activating, deactivating, or other functions of a component in the bobber cap device 106. Such an instruction may include activating a color light remotely without the user having physical access to the bobber cap.

In an embodiment, the bobber cap device 108 may receive outputs from the bobber cap device 106. For example, when the pressure or force sensor senses a fish or that some lights have been activated, the bobber cap device 106 may send notifications to the bobber cap device 108 notifying the color lights that are turned on or other functionality notifications of the bobber cap. In another embodiment, the bobber cap device 108 may continuously monitor the state and status of the bobber cap through continuous updating with the bobber cap device 106. In a further embodiment, components may be attached to the fishing line also and may be read and information may be sent to bobber cap device 108 through bobber cap device 106 or by a standalone device for those components.

In an embodiment, the application on bobber cap device 108 with information sent from bobber device 106 or an application on bobber device 106 may further send various fishing information to a cloud, social network, or other networks automatically. For example, the applications may send fish caught information, e.g., weight of the total fish caught as detected by sensor components, to a social network or to other specified devices, e.g., devices of individuals specified by the user. This allows for competition fishing where the statistic of the user's catch (or totaling the group's catch) may be recorded automatically.

In a further embodiment, a geolocation component on the bobber cap may be used to keep track of the location of the bobber cap. For example, referring to FIG. 7, if the jug fishing network 2400 is allowed to be freely moving in the water, a GPS or other geolocation component may be used to send geolocation information to a tracking device, i.e., bobber cap device 108.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as a discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art or may be later derived. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on a programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Further, systems described can include at least one computer readable medium or memory for holding instructions programmed according to the teachings of the invention and for containing data structures, tables, records, or other data described herein. Common forms of computer-readable media can include, for example, a floppy disk, a flexible disk, hard disk, memory disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the embodiments of the present invention can initially be borne on a magnetic disk of a remote computer connected to one or more network. In such a scenario, the remote computer can load the instructions into main memory and send the instructions, for example, over a telephone line using a modem. A modem of a local computer system can receive the data on the telephone line and use an infrared transmitter to convert the data to an infrared signal and transmit the infrared signal to a portable computing device, such as a PDA, a laptop, an Internet appliance, etc. An infrared detector on the portable computing device can receive the information and instructions borne by the infrared signal and place the data on a bus. The bus can convey the data to main memory, from which a processor retrieves and executes the instructions. The instructions received by main memory can optionally be stored on a storage device either before or after execution by processor.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. For example, in the foregoing description various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this description, with each claim standing on its own as a separate preferred embodiment of the disclosure.

Moreover, though the description has included a description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A fishing apparatus, comprising:
a housing;
a spring fitted into a space of the housing;
a cylinder fitted into the space, wherein the spring is configured to act against the housing and the cylinder; and
a hooked-wire fitted into a length of the cylinder, the hooked-wire comprising a hook end, wherein
the cylinder is configured to compress the spring at an application of a pressure and to expose the hook end of the hooked-wire, and wherein
a fishing line is configured to be hooked onto the hook end.

2. The fishing apparatus of claim 1, wherein an interior side of the housing comprises a fitting configured to fit the housing on a bottle.

3. The fishing apparatus of claim 2, further comprising one or more components at an end of the housing, wherein the components are inside the bottle when the housing is fitted on the bottle.

4. The fishing apparatus of claim 2, wherein the fitting comprises a compression fitting, a screw fitting, or a twist fitting.

5. The fishing apparatus of claim 3, wherein the one or more components comprise one or more color lights.

6. The fishing apparatus of claim 1, wherein the housing comprises metal and/or plastic material.

7. The fishing apparatus of claim 3, wherein the components comprise a network component.

8. The fishing apparatus of claim 3, wherein the components comprise a geolocation component.

9. The fishing apparatus of claim 8, wherein the geolocation component comprises a Global Positional System transmitter/receiver.

10. The fishing apparatus of claim 3, wherein the components comprise a mechanical or electrical sensor.

11. The fishing apparatus of claim 10, wherein the sensor comprises a pressure and/or force sensor configured to detect a force of tug on the fishing line attached to the hooked-wire.

12. The fishing apparatus of claim 11, wherein the pressure and/or force sensor is configured to tune one or more color lights attached to the housing depending on the force detected.

13. The fishing apparatus of claim 7, wherein the network component is configured to communicate with a second device through the network component.

14. The fishing apparatus of claim 13, wherein at least one of the components is configured to be controlled by the second device through the network component.

15. The fishing apparatus of claim 13, wherein at least one of the components is configured to transmit data to the second device through the network component.

16. The fishing apparatus of claim 13, wherein at least one of the components is configured to transmit data to one or more of a third-party device, a social network site, a server, and a cloud.

17. The fishing apparatus of claim 16, wherein the data pertains to information detected by one or more sensors attached to the housing.

18. The fishing apparatus of claim 17, wherein the information comprises statistics regarding fishes caught using the fishing apparatus

19. A fishing apparatus, comprising:
a housing;
a rod attached to an end of the housing; and
a hook at an end of the rod, wherein
a fishing line is configured to be hooked onto the hook.

20. A linked fishing apparatus, comprising:
one or more fishing apparatuses;
one or more weights; and
one or more baits, wherein
the fishing apparatuses, weights, and baits are linked, and wherein
each of the fishing apparatuses comprise:
a housing;
a spring fitted into a space of the housing;
a cylinder fitted into the space, wherein the spring is configured to act against the housing and the cylinder; and
a hooked-wire fitted into a length of the cylinder, the hooked-wire comprising a hook end, wherein
the cylinder is configured to compress the spring at an application of a pressure and to expose the hook end of the hooked-wire, and wherein
a fishing line is configured to be hooked onto the hook end.
